(19) United States
(12) Patent Application Publication
(10) Pub. No.: US 2004/0056494 A1
(43) Pub. Date: Mar. 25, 2004

(54) Method and means for forming and lifting parcels of goods and an apparatus for forming such parcels

(76) Inventors: Tor Kokkersvold, Langangen (NO); Peter Toft, Porsgrunn (NO)

Correspondence Address: WENDEROTH, LIND & PONACK, L.L.P., 2033 K STREET N. W., SUITE 800, WASHINGTON, DC, 20006-1021, US

(21) Appl. No.: 10/416,220

(22) PCT Filed: Oct. 31, 2001
(86) PCT No.: PCT/NO01/00433

(30) Foreign Application Priority Data
Nov. 10, 2000 (NO) 20005702

(51) Int. Cl. B66C 1/00

(52) U.S. Cl. 294/74; 294/68.3; 294/67.4

(57) ABSTRACT

Method and means for forming and lifting parcels comprising least two stacks or units of goods (A, B) comprising a lifting sling or a load carrying band (1) that is arranged to surround the stacks in a manner where it follows the outer periphery of the stacks thus forming a parcel (P). The invention further comprises an apparatus for forming such parcels. A loop of the band is arranged to protrude upwards in an intermediate space between the stacks to form a lifting eye (3) above said stacks. The load carrying band covers at least partly the outer periphery of the stacks and partly the front- and back sides thereof. The sides of the stacks can be covered by a cover material kept in place by the sides of the load carrying band. Improved stability and protection of the goods may be achieved in accordance with the invention.

The present invention relates to a method for forming large parcels of goods comprising a lifting sling or load carrying device that can be lifted by a lifting device. The invention further comprises such parcels and an apparatus for forming same. In particular the invention relates to forming parcels or packages of at least two units of goods comprising one or more bands or webs that covers the outer edge of the parcel.

The Applicant's own patent application WO 98/26977 discloses a lifting sling or belt that surrounds one pair of stacks of units of goods, where the sling is in the form of a closed loop of a belt having a width substantially equal to the transverse with of the stacks. This solution will imply good stability of the load to be handled.

With the present invention the above mentioned solution can be improved. In accordance with the present invention it is now possible to handle goods comprising at least one pair of stacks or units of goods surrounded by one or more load carrying bands, where the band(s) has (have) provisions to cover the outer edges of the parcel, i.e. at least a part of the side-faces of the parcel and a part of the outer periphery of the parcel, which will imply improved stability of the parcel in handling situations. Further, the invention relates to improvements where the units of goods to be handled can be formed as a packaged parcel by means of the load carrying device.

In the following the present invention will be further described by examples and figures where:

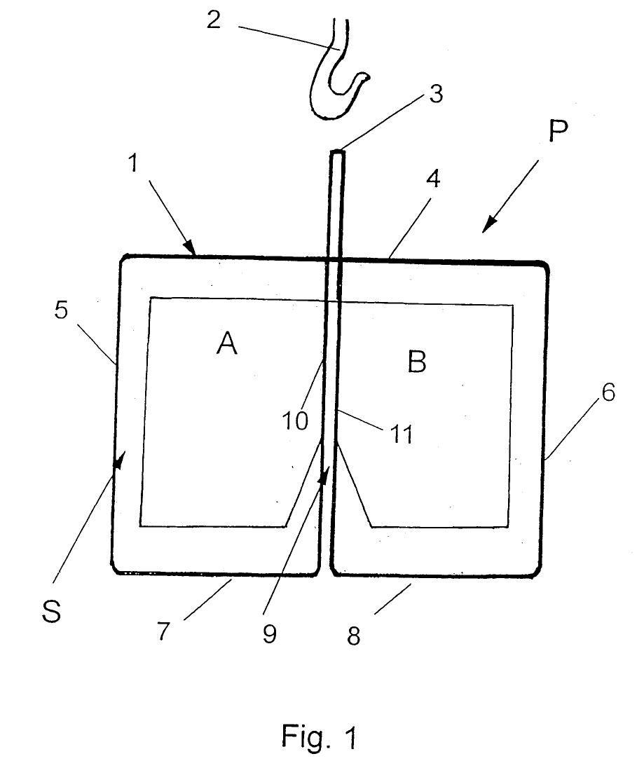

FIG. 1 is a sketch showing a load carrying band surrounding two units of goods A and B forming a parcel, seen in a front view,

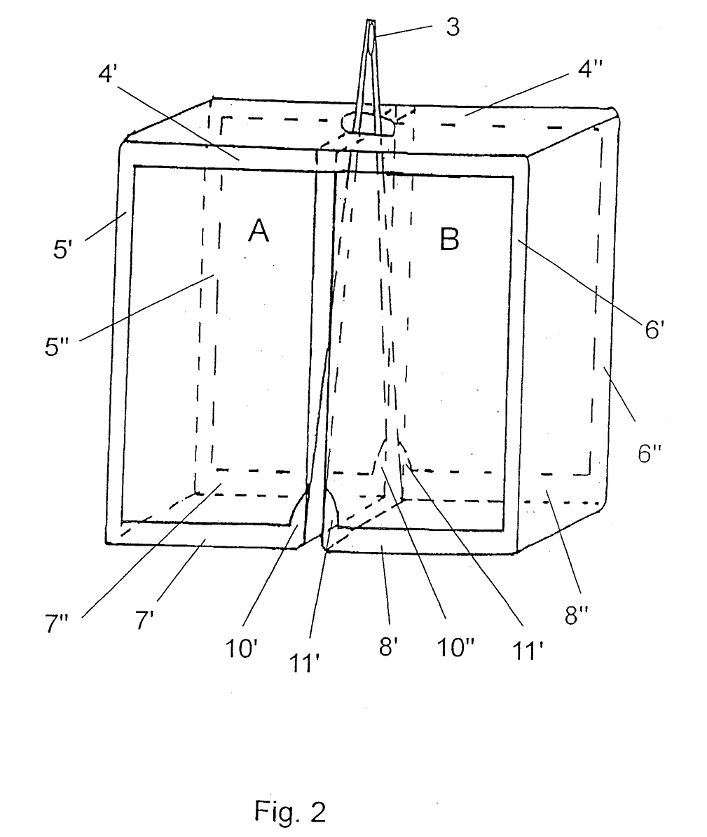

FIG. 2 is a sketch showing a parcel similar to that of FIG. 1, seen in a perspective view,

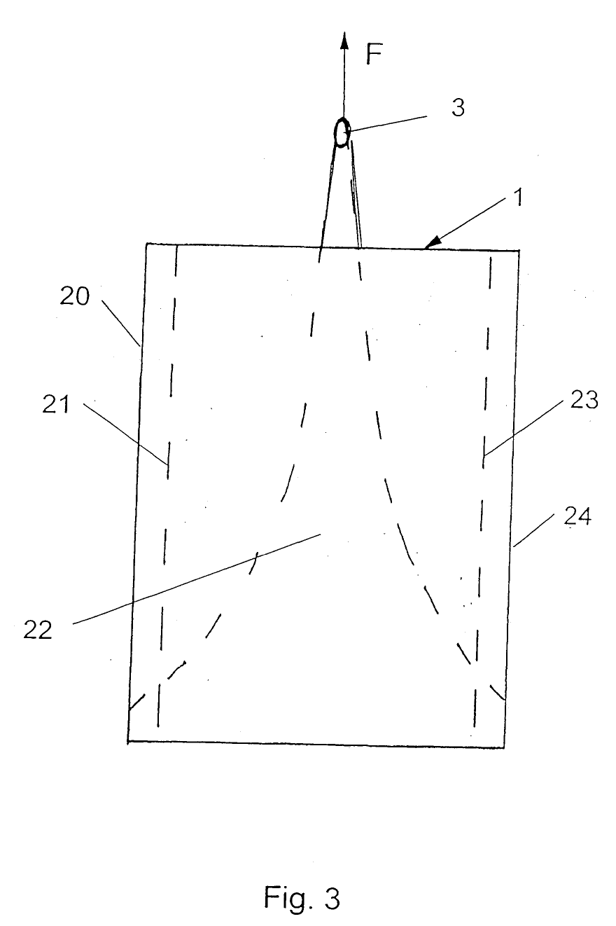

FIG. 3 is a sketch showing a parcel similar to that of FIG. 2 to be formed, seen in a side view.

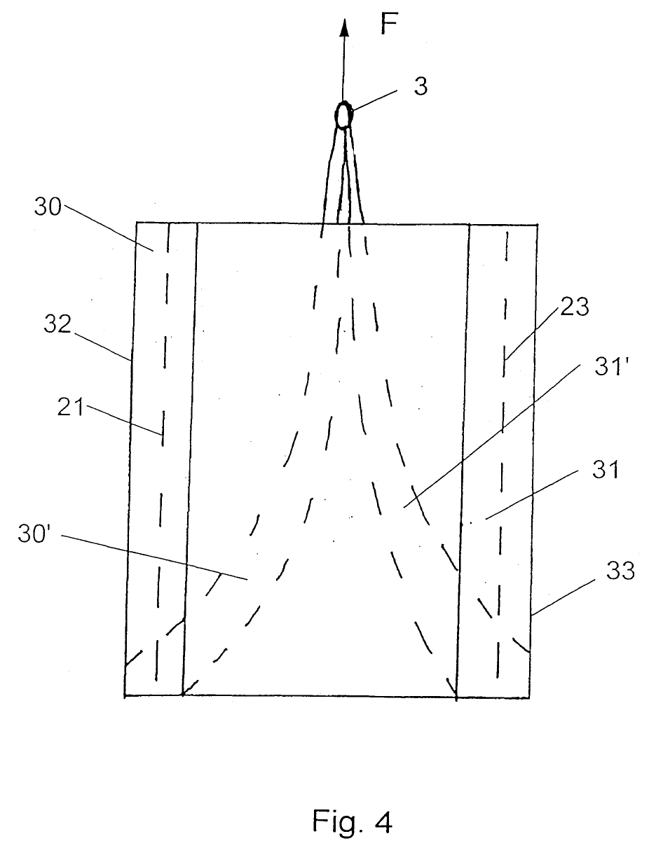

FIG. 4 is a sketch showing a parcel similar to that of FIG. 3 to be formed in a side view, involving two bands,

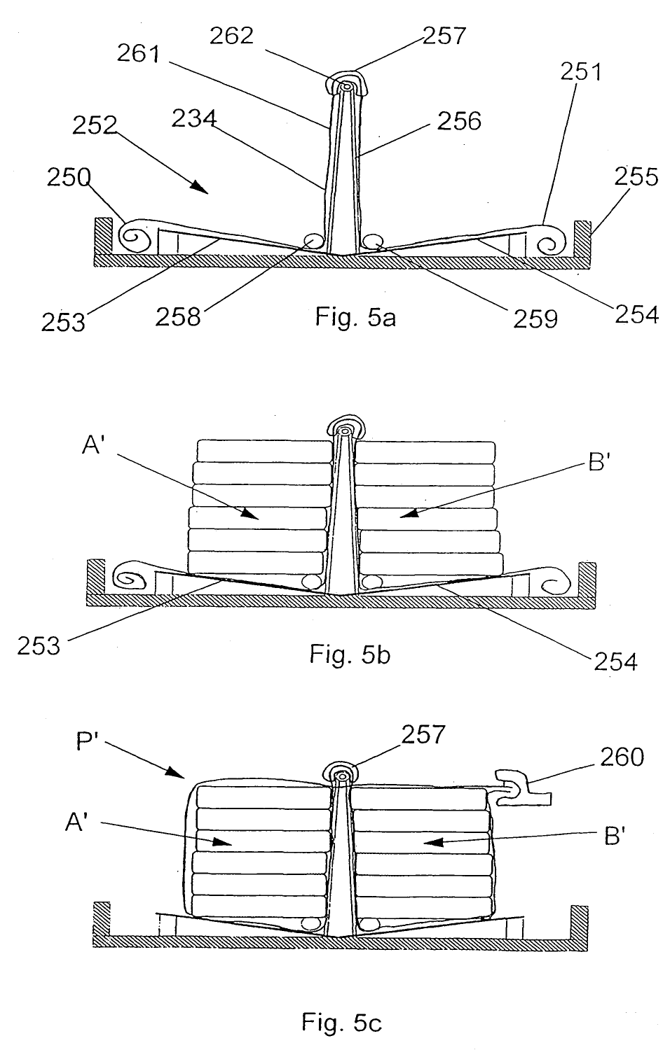

FIGS. 5a-c show a sketch in side view where a load carrying band is applied to two units of goods,

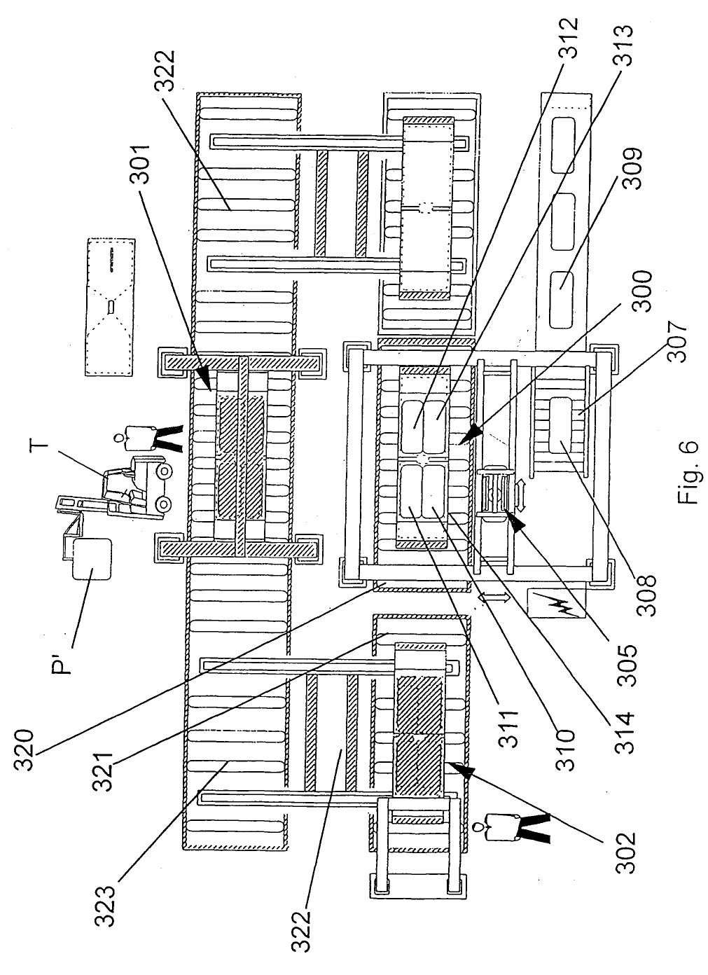

FIG. 6 shows a sketch seen from above of a parcel producing facility.

In FIG. 1 there is shown two stacks or units of goods, A and B that may comprise piles of sacks or any other type of load that can be surrounded by a band 1, thus forming a parcel P. The band 1 is of a width appropriate for securing the load in a satisfactory manner. For some type of loads this implicates that the band has a width positively wider than the width of the load. In this manner the protruding part of the band will tend to fold inwards against the front- and back sides of the load as indicated by reference numeral S, and consequently the goods will be secured against falling out of the load carrying band.

It should be understood that the band 1 can be applied as a endless loop where it is made out of pre-cut lengths where the ends of the band are joined by an appropriate joining operation such as sewing, glueing, welding or the like. Alternatively, the joining operation may be performed in situ as will be explained in connection with FIG. 5.

The band can be of any convenient material such as polyethylene, polypropylene, paper, jute etc. The band may be constituted of any type of web material such as an homogenous band, a net or woven fabric, a band with sides of a stretchable or heat-shrinkable material, or a band made out of a stretchable or heat-shrinkable material as a whole. The term stretchable material is here intended to imply both elastic and deformable (ductile) material or materials having both elastic and deformable properties. Further, the front- and back sides of the parcel may be protected by a cover material put on place before the band is forced to lay onto the side surfaces. The application of a cover material in connection with a band that covers the whole outer pheriphery of the parcel in accordance with the present invention, makes it possible to obtain a reasonably weatherproof packaging provided with lifting provisions such as a lifting eye symmetrically arranged with respect to the load. In such an embodiment the band may be provided with a heat shrinkable material at its outermost sides, which will after its shrinkage be in firm abutment with the side cover materials.

As seen in the figure, the band is formed to surround the stacks or units of goods A and B where it has an upper planar section 4, two sides 5 and 6, two bottom parts 7 and 8 and finally a central, vertically projecting part 9. The central part 9 consists of a first vertical extending part of the band 10 connected with the bottom part 7, and a second vertical extending part 11 connected with the bottom part 8. The two vertically extending parts 10 and 11 are connected together through an intermediate section 3 at a certain height above the parcel P in which there can be introduced a lifting device 2. Advantageously the mutual frictional forces between the load carrying band and the goods and between parts of the band itself (section 10 and 11) are that high that the load carrying band will be of a self-locking nature i.e. as the goods are surrounded by the band in a proper manner, the band will rest firmly and the intermediate section 3 will be maintained in its correct position.

The lifting device may be formed as a hook 2 or the like with a geometrical shape suitable for entering into the intermediate section 3, that can be formed as a lifting eye.

The intermediate section may be provided with reinforcement to render a secure and even force distribution to the vertical parts 10, 11 of the band. For instance, the intermediate section may be pleated and surrounded by a reinforcing sleeve. The reinforcing sleeve may be produced out of any convenient material, such as cardboard paper, plastics material, metallic materials etc., depending on parameters such as price, strength and durability. In the case more than one band are applied in accordance with the present invention, the reinforcing sleeve will in addition have the function that it will keep the individual loops or lifting eyes gathered as one unit or lifting eye.

FIG. 2 shows a sketch of a parcel similar to that of FIG. 1, seen in a perspective view. In the figure, the part of the load carrying device that covers partly the front side of the parcel P consisting of two stacks A and B, is indicated by 5′, 7′, 10′, 11′, 8′, 6′ and 4′ similar to that of the parts of the band surrounding the parcel P. The parts covering partly the back side of the parcel P is indicated by 5″, 7″, 10″, 11″, 8″, 6″ and 4″.

FIG. 3 is a sketch showing a parcel similar to that of FIG. 2, seen in a side view. In the sketch the parcel is just pre-assembled, i.e. the load carrying band has not been firmly tied up around the stacks. The outer edges 20, 24 of the band protrudes beyond the sides of the stacks 21, 23. In between the stacks the band 22 protrudes vertically and forms a lifting eye 3. In case the protruding side parts of the band are of a heat shrinkable material, heat may be applied to these side parts to intitiate a firm abutment of these parts to the front- and back side of the parcel P.

In other applications there may be applied at least two bands, see FIG. 4. In this situation each individual band 30, 31 will cover partly the periphery of the load 21, 23 and partly the front- and back sides of the load by side parts 32, 33. In this sketch the bands are just pre-assambled and the side parts of the bands are not brought into firm abutment with the side surfaces of the load. In the intermediate space between the stacks the bands 30′ and 31′ are indicated, where they are joined together in one lifting eye 3, for instance by a reinforcing sleeve (not shown). In this stiuation, it should be understood that the width of the bands can individually be more narrow than the width of the load itself. Further, several individual bands in between the two outer bands can be applied, if desired.

FIGS. 5a-c shows a sketch in side view where a load carrying band is applied to two units of goods, where the ends of the band are joined after the band is brought to surround two units of goods. In FIG. 5a there is shown a load carrying band 234 having spooled ends 250, 251. The band is arranged in an application unit 252, having two inclined base platforms 253, 254 onto which the band is brougth to rest. The platforms are arranged upon a base structure 255. In the middle of the two platforms there is arranged in an upwards manner a stationary support structure 256 onto which the load carrying band forms a loop 261. The height of the structure 256 in this embodiment is higher than the actual height of the load to be handled. In the embodiment shown in the figure the band 234 is pleated and there is arranged a reinforcing sleeve 257 that is situated on the top of the structure. The top part of the loop thus will form a lifting eye 262 that can be served by a lifting device. Slightly above the inclined platforms and close to the support structure, there are arranged elements or rollers 258, 259 whose purpose is to tie-in the load carrying band in these regions. It should be understood that the load in some cases can be higher than the structure 256. The top part (lifting eye) of the loop then can be retrieved by lowering the lifting device down between the two stacks A′, B′ or it can be applied an additional strap between the lifting device and the lifting eye (not shown).

In FIG. 5b there is arranged two units of load A′, B′ upon the platforms 253, 254 respectively.

In FIG. 5c the spooled ends 250, 251 of the load carrying band 234 as shown in FIG. 6a are unwound and arranged to surround the two units of goods A′, B′. The two ends of the band are in this embodiment put together at one side of the upper part of the units of goods and joined together by a joining device 260 that may be a device for performing sewing, glueing, welding or similar joining operations. Following the joining operation of the end of the band, the parcel P′ thus formed may be lifted by entering ′a lifting device beneath the sleeve 257. As will be seen in the figure, the sides of the support structure 256 facing the load have a slight angular deviation with respect to the perpendicular to the base structure. This angular deviation together with the inclination of the base platforms 253, 254 will as such contribute to initiate a pulling force in the load carrying band as the load being lifted out of the application unit 252, because the two units of load then will tend to meet along their mutual facing sides.

FIG. 6 shows from above, a sketch of an installation for forming parcels P′ with a load carrying band 314 comprising a load carrying band applying station 300, a stretching station 301 and a band end joining station 302. In this arrangement, load carrying band 314 is fed into the applying station in an appropriate manner. A manipulator 305 is arranged to take goods, for instance sacks 308, 309 arriving via a conveyor 307, and to enter the goods into the load carrying band 314 that is arranged in advance at the applying station. In the figure piles of sacks 310, 311, 312, 313 are arranged into the band 314. Following the completion of the process entering the goods into the band, the pre-formed parcel is transported by means of conveyors 320, 321, to a joining station 302. The joining operation can be performed in accordance with that described under FIGS. 5a-c. After being joined, the parcel is further transported by means 322, 323 to the stretching station 301 for appropriate stretcing of the band. The stretching operation can be performed by applying a lifting force, for instance 2-3 times the weight of the load, while restricting the load against being lifted. Finished parcels can be lifted and removed by a truck T or corresponding device having appropriate lifting gear.

In experiments it has been shown that with a load carrying band made out of a material with appropriate stretching properties, it is possible to achieve that the band folds inwards to the front- and back surfaces of the units of goods. This effect can be explained by the fact that the outer edge part of the band will be forced to pass a longer distance that the central part of the band when the loop is formed and gathered in one lifting eye. Hence there will occur stretching forces in the outer edge part of the band which tends to force the band to lay onto the side surfaces of the units of goods. It should be understood that the stretching properties of the band may be achieved by the construction of the band itself manufactured as a net or a woven web or the like, but in addition the stretching properties may be related to the elastic and ductile properties of the material itself.

1. A method for forming and lifting parcels comprising at least two stacks or units of goods (A, B) where one or more lifting slings or load carrying bands (1) are arranged to surround the stacks in a manner to follow the outer periphery of the stacks thus forming a parcel (P), and where a loop of said band is further arranged to protrude upwards in an intermediate space between said stacks where it forms a lifting eye (3) above the parcel,
characterised in that
the load carrying band (1) is arranged in a manner where it covers at least partly the outer pheriphery of the stacks and partly the front- and back sides thereof.

2. A method in accordance with claim 1,
characterised in that
the load carrying band (1) is arranged to clamp the side cover material to the sides of the stacks.

3. Parcel comprising at least two stacks or units of goods (A, B) comprising at least one lifting sling or a load carrying band that is arranged to surround the stacks in a manner where it follows the outer periphery of the stacks thus forming a parcel (P), and where a loop of the band is arranged to protrude upwards in an intermediate space between the stacks to form a lifting eye (3) above said stacks,
characterised in that
the load carrying band (1) covers at least partly the outer pheriphery of the stacks and where partly the front- and back sides of the stacks are covered by the sides (20, 24) of the band.

4. Parcel in accordance with claim 3,
characterised in that
the load carrying band is made out of a stretchable material, allowing the band to be streched and folded inwards against the front- and back surfaces of the stacks (A, B).

5. Parcel in accordance with claim 3,
characterised in that
the load carrying band comprises a load carrying section (1) that covers at least partly the outer periphery of the stacks (A, B), and further have integrated side parts (20, 24) intended to cover partly the sides of the stacks.

6. Parcel in accordance with claim 4,
characterised in that
at least the side parts are made out of a heat shrinkable material.

7. Parcel in accordance with claim 3,
characterised in that
the sides of the parcel are protected by a cover material fixed by the side parts of the band.

8. Parcel in accordance with claim 3,
characterised in that
the lifting eye is reinforced by a sleeve or the like.

9. Parcel in accordance with claim 3,
characterised in that
two load carrying bands (30, 31) are arranged to cover at least partly the outer pheriphery of the stacks and partly the front- and back sides of the stacks.

10. Parcel in accordance with claim 9,
characterised in that
the two load carrying bands are gathered and reinforced by a sleeve or the like.

11. Apparatus for forming parcels comprising at least two stacks or units of goods (A′, B′) where a lifting sling or a load carrying band (234) is arranged to surround the stacks in a manner to follow the outer contour of the stacks thus forming a parcel (P′), and where a loop (261) of the band is further arranged to protrude upwards in an intermediate space between said stacks, the loop thus forming a lifting eye (262) that can be served by a lifting device for lifting the parcel (P′), the apparatus comprises two elements or rollers (258, 259) positioned in the vincintiy of two mutually facing corners of the two units of goods (A′, B′), and a device (256) for entering and forming the loop between said units (A′, B′) and said two elements (258, 259), the apparatus further comprises means (260) for joining the two ends of the load carrying band (234),
characterised in that
the device for forming the loop is constituted by a stationary support structure (256) onto which the load carrying band forms the loop, the structure is further arranged in an upwards manner and is preferably higher than the height of the goods to be handled.

12. Apparatus in accordance with claim 11,
characterised in that
it comprises one station (300) for entering load (310, 311, 312, 313) into a load carrying band (314) for pre-forming a parcel, where the apparatus further comprises at least one band end joining station (302) and a band stretching station (301) for finishing the forming of the parcel (P′).
